(19) United States
(12) Patent Application Publication
(10) Pub. No.: US 2024/0372662 A1
(43) Pub. Date: Nov. 7, 2024

(54) MOBILE DEVICE FOR BOOSTING SHORT-RANGE WIRELESS CONNECTION, WIRELESS COMMUNICATION SYSTEM INCLUDING MOBILE DEVICE, AND METHOD OF OPERATING MOBILE DEVICE

(71) Applicant: Samsung Electronics Co., Ltd., Suwon-si (KR)

(72) Inventor: Youngmin Ko, Suwon-si (KR)

(21) Appl. No.: 18/533,273

(22) Filed: Dec. 8, 2023

(30) Foreign Application Priority Data
May 4, 2023 (KR) 10-2023-0058393

(51) Int. Cl. H04L 5/00; H04W 72/54

(52) U.S. Cl. CPC H04L 5/0046; H04L 5/0048; H04W 72/54

(57) ABSTRACT

A method of operating a mobile device includes establishing a main channel between a first mobile device and a host device, establishing a sub channel between the first mobile device and the host device via a second mobile device, and communicating between the first mobile device and the host device using one of the main channel and the sub channel.

### CROSS-REFERENCE TO RELATED APPLICATION(S)

This application claims benefit of priority to Korean Patent Application No. 10-2023-0058393 filed on May 4, 2023 in the Korean Intellectual Property Office, the disclosure of which is incorporated herein by reference in its entirety.

### BACKGROUND

Aspects of the present inventive concept relate to a mobile device for boosting a short-range wireless communication connection such as a Bluetooth™ connection, a wireless communication system including the same, and a method of operating the same.

In general, portable devices tend to be wireless for ease of use. In addition, it is possible to connect multiple accessory slave devices to a single host device such as a mobile phone. Such a connection mainly uses multi-access using Bluetooth™, a standard short-range wireless communication protocol. However, a Bluetooth™ connection is based on a vertical connection between a host layer and a slave layer of a single device. Thus, when crosstalk or a signal shadow region occurs, signal loss or delay may occur. For example, in a confined space such as a subway, in a state in which multiple wireless slave devices are connected, music being played may be interrupted due to crosstalk or a signal blockage by clothes with a lot of metal decorations. Such crosstalk or signal blockage may cause loss of connection (or delay) and adversely affect user experience. Accordingly, it is possible to increase signal power to maintain the connection, but the output is limited for each Bluetooth™ version.

### SUMMARY

An aspect of the present inventive concept provides a mobile device resolving an issue associated with crosstalk or signal blockage during Bluetooth™ connection, a wireless communication system including the same, and a method of operating the same.

According to an aspect of the present inventive concept, a method of operating a mobile device includes establishing a main channel between a first mobile device and a host device, establishing a sub channel between the first mobile device and the host device via a second mobile device, and communicating between the first mobile device and the host device using one of the main channel and the sub channel.

According to another aspect of the present inventive concept, a mobile device includes a memory device storing transmission data or reception data, and a communication chip transmitting the transmission data to an external host device via wireless communication or receiving the reception data from the host device via the wireless communication. The communication chip may establish a main channel with the host device via a layer connection with the host device or establish a sub channel with the host device via an interconnection with another mobile device, and communicate with the host device using one of the main channel and the sub channel.

According to another aspect of the present inventive concept, a wireless communication system includes a first mobile device communicating with a host device, and a second mobile device communicating with the host device. The first mobile device is configured to establish a main channel between the first mobile device and the host device according to a direct connection, and to establish a sub channel between the first mobile device and the host device according to an interconnection through the second mobile device.

According to another aspect of the present inventive concept, a method of operating a wireless communication device includes performing a first connection between a master device and a first slave device, performing a second connection between the master device and a second slave device, and performing an interconnection for data synchronization between the first slave device and the second slave device, so that one of the first slave device and the second slave device serves as a hub connection between the master device and the other of the first slave device and the second slave device.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a diagram illustrating a wireless communication system 10 according to an example embodiment of the present inventive concept;

FIG. 2 is a diagram illustrating a host device 100 according to an example embodiment of the present inventive concept;

FIG. 3 is a diagram illustrating a mobile device 210 according to an example embodiment of the present inventive concept;

FIG. 4 is a flowchart illustrating a method of operating a mobile device according to an example embodiment of the present inventive concept;

FIG. 5 is a flowchart illustrating a method of communicating a mobile device 210 according to an example embodiment of the present inventive concept;

FIG. 6 is a diagram illustrating a mobile device 210a according to another example embodiment of the present inventive concept;

FIG. 7 is a flowchart illustrating a method of operating a mobile device according to an example embodiment of the present inventive concept;

FIG. 8 is a flowchart illustrating a method of operating a mobile device according to an example embodiment of the present inventive concept;

FIG. 9 is a flowchart illustrating a method of operating a mobile device according to another example embodiment of the present inventive concept;

FIG. 10 is a ladder diagram illustrating a communication connection of a wireless communication system according to an example embodiment of the present inventive concept; and

FIG. 11 is a diagram illustrating an electronic device 1200 according to an example embodiment of the present inventive concept.

### DETAILED DESCRIPTION

Hereinafter, example embodiments of the present inventive concept will be described clearly and specifically such that a person skilled in the art easily could carry out example embodiments using the drawings.

A mobile device, a wireless communication system including the same, and a method of operating the same according to an example embodiment of the present inventive concept may implement communication using a layer connection between a master device and a slave device and an interconnection among slave devices. The mobile device, the wireless communication system, and the method of operating may enable continuous data (or data stream) transmission via data flow paths according to the interconnection, even when data blockage or disconnection occurs in an individual slave device. For example, when data blockage of a main channel corresponding to the layer connection is expected, data may be simultaneously transmitted using an auxiliary channel corresponding to the interconnection.

The mobile device, the wireless communication system including the same, and the method of operating the same according to an example embodiment of the present inventive concept may prevent disconnection caused by coverage degradation via the hierarchical structure connections and the interconnection within the same layer. Signal strength between a master device and a slave device may be monitored, thereby enabling continuous data transmission using a detour path (or bypass path) in the event of connection instability. For example, signal disconnection of wireless earphones or headphones may be improved via a data detour such as a smartwatch or the like.

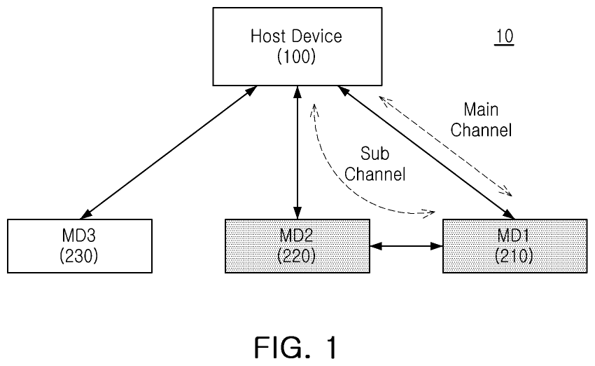

FIG. 1 is a diagram illustrating a wireless communication system 10 according to an example embodiment of the present inventive concept. Referring to FIG. 1, the wireless communication system 10 may include a host device 100 and a plurality of mobile devices 210, 220, and 230 (MD1, MD2, and MD3).

The host device 100 may be a master device. For example, the host device 100 may be an Internet of Things (IoT) device. In an example embodiment, the IoT device may be personal electronics device such as a smartphone. The host device 100 may be implemented to establish a connection between the mobile devices 210 to 230 using a page scanning operation.

In general, a page scanning operation in Bluetooth™ communication may establish a connection between Bluetooth™ devices. In this process, two types of access codes, such as general inquiry access code (GIAC) and a dedicated inquiry access code (DIAC), may be used. The GIAC may be an access code used to search for general Bluetooth™ devices. All nearby Bluetooth™ devices may be searched using the GIAC. As a result, a list of available Bluetooth™ devices may be obtained. The DIAC may be an access code used to search for a specific Bluetooth™ device or service. The DIAC may be for a specific application or service defined by the Bluetooth™ Special Interest Group. A device, providing a specific service, may be found and the device may be hidden from general users using the DIAC. The page scanning operation may be performed via the following process. A paging device (for example, a host device) may search for nearby Bluetooth™ devices using the GIAC or DIAC. When a paging target (for example, a mobile device) responds to a corresponding access code, the paging device may attempt to establish a connection with the device. Once the connection is established, data communication may be performed between the two devices. The page scanning operation using GIAC and DIAC may provide an efficient and secure method for establishing a connection between Bluetooth™ devices. Typically with a short-range wireless communication protocol such as Bluetooth™ transmission power is limited to up to about 2.5 milliwatts, and range is limited to up to about 10 meters.

The host device 100 may search for the mobile devices 210 to 230 within a specific range using the GIAC and DIAC, transmit a paging message, receive a response message to the paging message, and establish a connection with the mobile devices 210 to 230.

Each of the plurality of mobile devices 210 to 230 may be a slave device performing Bluetooth™ communication with the host device 100. In general, Bluetooth™ communication, one of wireless communication technologies, may be mainly used for data transmission between devices requiring mobility. One of the characteristics of Bluetooth™ is low-power communication technology. Accordingly, Bluetooth™ has been widely used in chargeable devices having a small battery. Bluetooth™ may be supported by most devices, and Bluetooth™ devices may be connected via a pairing process. During such a pairing process, the Bluetooth™ devices may recognize each other and perform secure authentication. Bluetooth™ may add multi-pairing and multi-room audio functions.

In an example embodiment, each of the mobile devices 210, 220, and 230 may be an accessory device connected to a smartphone as the host device 100. For example, the accessory devices may be an earphone, a headset, a speaker, a charger, an external battery, a smartwatch, or the like. In another example embodiment, each of the mobile devices 210, 220, and 230 may be an accessory device connected to an electronic control device of a vehicle as the host device 100.

Referring back to FIG. 1, the wireless communication system 10 according to some embodiments of the present inventive concept may perform communication between the host device 100 and the mobile devices 210 to 230 via different types of first and second Bluetooth™ connections.

The first Bluetooth™ connection may be a layer connection between the host device 100 and the mobile devices 210 to 230. Here, the host device 100 may be a first layer (master layer), and each of the mobile devices 210 to 230 may be a second layer (slave layer). The first Bluetooth™ connection may be a 1:1 connection between a host device and a slave device. In this case, a 1:1 connection may mean a direct connection between two devices with no intermediate devices transferring or relaying the communication therebetween.

The second Bluetooth™ connection may be an interconnection between the mobile devices 210 to 230. Here, the interconnection may be a connection between the same layers (for example, the second layer). The first layer may refer, for example, to a master level device, and the second layer may refer to a slave level device. A first layer connection may refer to a connection between a master and a slave, and a second layer connection may refer to a connection between two slaves. The wireless communication system 10 according to an example embodiment of the present inventive concept may enable an N:N connection between a host device and a slave device using the interconnection. In this case, a N:N connection refers to a connection between two devices with at least one intermediate device transferring or relaying communications therebetween.

As illustrated in FIG. 1, the wireless communication system 10 may maintain a plurality of connection paths. For example, the host device 100 and the first mobile device MD1 210 may simultaneously transmit data via a main channel and a sub channel. Here, the main channel may be a channel formed via a first layer connection (e.g., directly between devices at two different layers), and the sub channel may be a channel formed via an interconnection (e.g., indirectly between devices at two different layers, through a third device). A sub channel between the host device 100 and the first mobile device 210 may be a channel via the second mobile device MD2 220. In this case, the second mobile device 220 may function as a hub (or router).

An additional interconnection (e.g., in addition to a direct communication connection) between the first mobile device 210 and the second mobile device 220 may be maintained by setting a target device (for example, MD1) in which disconnection frequently occurs and a device to use a reroute path (for example, MD2). The host device 100 may simultaneously transmit data to the first and second mobile devices 210 and 220.

The second mobile device 220 may monitor a data interconnection with the first mobile device 210. The second mobile device 220 may detect whether data loss occurs according to a monitoring result. The second mobile device 220 may be used as a type of data hub for stable data transmission of the first mobile device 210. The second mobile device 220 may allocate a portion of an available system resource to a data hub operation, if necessary. Each of the mobile devices 210 to 230 may perform point-to-point Bluetooth™ communication not only between themselves and the host device 100, but between themselves and other mobile devices 210 to 230.

The wireless communication system 10 according to an example embodiment of the present inventive concept may minimize disconnection by setting a connection priority device in various situations in which signal interference or connection restrictions occur. In this case, power and computational resources may be used for an additional interconnection between slave devices. In an example embodiment, two or more slave devices may be simultaneously used for a Bluetooth™ connection using an interconnection. The wireless communication system 10 according to an example embodiment of the present inventive concept may achieve Bluetooth™ connection boosting by changing a 1:1 host-slave connection to an N:N host-slave connection.

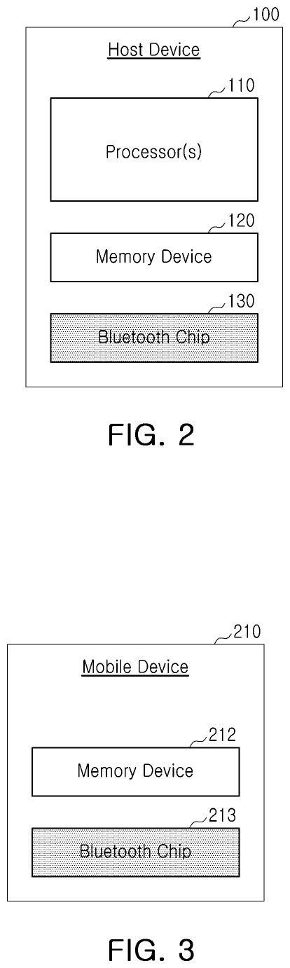

FIG. 2 is a diagram illustrating a host device 100 according to an example embodiment of the present inventive concept. Referring to FIG. 2, the host device 100 may include a processor 110, a memory device 120, and a communication chip 130.

The processor 110 may be implemented to control overall operations of the host device 100. The processor 110 may execute applications providing Internet browsers, games, videos, and the like. In an example embodiment, the processor 110 may include one processor core (single core) or may include a plurality of processor cores (multi-core). In an example embodiment, the processor 110 may further include a cache memory positioned internally or externally.

The processor 110 may execute software to control at least one other component (for example, a hardware or software component) of the host device 100 connected to the processor 110, and may perform various data processing or computation tasks. In an example embodiment, as at least part of data processing or computation, the processor 110 may store a command or data received from another component in a volatile memory, process the command or the data stored in the volatile memory, and store resulting data in a nonvolatile memory. In an example embodiment, the processor 110 may include a main processor 121 (for example, a central processing unit or an application processor), and an auxiliary processor (for example, a graphics processing unit, a neutral processing unit (NPU), an image signal processor, a sensor hub processor, or a communication processor) that is operable independently from, or in conjunction with, the main processor.

The memory device 120 may be implemented to store a control command code for controlling the host device 100, control data, or user data. The memory device 120 may include or be formed of at least one of volatile memory and nonvolatile memory. The nonvolatile memory may include or be read only memory (ROM), programmable ROM (PROM), electrically programmable ROM (EPROM), electrically erasable and programmable ROM (EEPROM), flash memory, phase-change RAM (PRAM), magnetic RAM (MRAM), resistive RAM (RRAM), ferroelectric RAM (FRAM), and the like. The volatile memory may include dynamic RAM (DRAM), static RAM (SRAM), synchronous DRAM (SDRAM), and the like.

The communication chip 130 may be implemented to communicate with an external device. The communication chip 130 may be implemented as a local area network (LAN), a wireless local area network interface such as Bluetooth™, Wireless Fidelity (Wi-Fi), or Zigbee, a power line communication (PLC), or a modem communication interface that is accessible to a mobile cellular network. The communication chip 130 may support new radio (NR) access technology. The NR access technology may support enhanced mobile broadband (eMBB), massive machine type communications (mMTC), or ultra-reliable and low-latency communications (URLLC). The communication chip 130 may support a high-frequency band (for example, mmWave band) in order to achieve a high data transmission rate, for example. The communication chip 130 may support various technologies for securing performance in the high-frequency band, such as beamforming, massive multiple-input and multiple-output (MIMO), full dimensional MIMO (FD-MIMO), array antenna, analog beamforming, and large-scale antenna.

In addition, the communication chip 130 may include a transceiver or receiver. The communication chip 130 may transmit or receive information from an access point or gateway via the transceiver or receiver. In addition, the communication chip 130 may communicate with a user device or another IoT device to transmit or receive control information or data on the IoT device.

FIG. 3 is a diagram illustrating a mobile device 210 according to an example embodiment of the present inventive concept. Referring to FIG. 3, the mobile device 210 may include a memory device 212 and a communication chip 213.

The memory device 212 may be implemented to store transmission data or reception data. The memory device 212 may be implemented with various types of volatile memories or nonvolatile memories.

The communication chip 213 may be implemented to transmit the transmission data to a host device 100 via wireless communication or to receive the reception data from the host device 100 via wireless communication. The communication chip 213 may establish a main channel with the host device 100 via a layer connection with the host device 100 or establish a sub channel with the host device 100 via an interconnection with another mobile device 220 (see FIG. 1), and may communicate with the host device 100 using one of the main channel and the sub channel. In an example embodiment, the communication chip 213 may be a dedicated chip for Bluetooth™ communication.

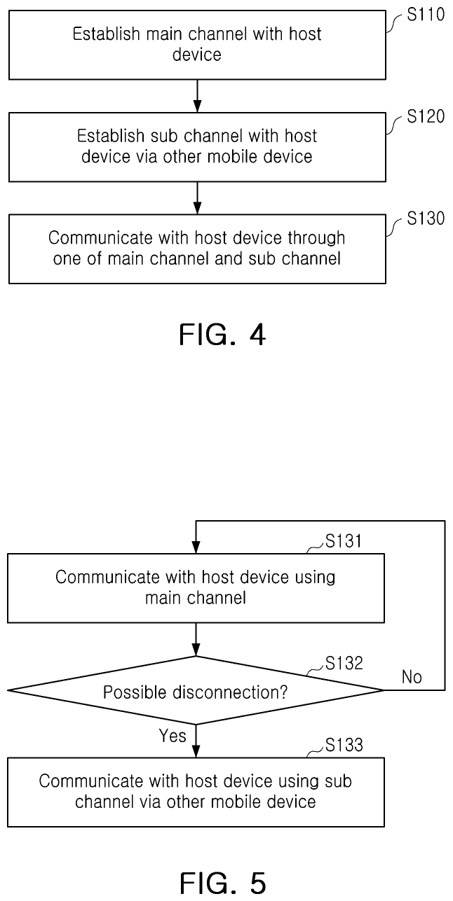

FIG. 4 is a flowchart illustrating a method of operating a mobile device according to an example embodiment of the present inventive concept. Referring to FIGS. 1 to 4, the mobile device 210 may operate as follows.

The mobile device 210 may establish a main channel with a host device 100 (S110). The mobile device 210 may establish a sub channel with the host device 100 via another mobile device (for example, 220 of FIG. 1) (S120). The mobile device 210 may perform communication via one of the main channel and the sub channel (S130).

In an example embodiment, the main channel and the sub channel may be established according to a Bluetooth™ communication protocol. In an example embodiment, a connection boosting mode, supporting the sub channel, may be set. In an example embodiment, when an operation mode is the connection boosting mode, the main channel and the sub channel may be simultaneously established. In an example embodiment, it may be determined whether a level of a received signal (for example, received signal strength indicator (RSSI)) transmitted from the main channel has a value less than or equal to a reference value. In an example embodiment, the mobile device may communicate with the host device 100 using the sub channel when the signal level has a value less than or equal to the reference value. In an example embodiment, a connection mode of wireless communication may be further determined. In an example embodiment, direct communication may be performed using the main channel directly connected to the host device 100 without establishing the sub channel when the connection mode is a power reduction mode (for example, Bluetooth™ low energy (BLE) mode). In an example embodiment, when the connection mode is the connection boosting mode, communication with the host device 100 may be performed using one of the main channel and the sub channel.

FIG. 5 is a flowchart illustrating a method of communication for a mobile device 210 according to an example embodiment of the present inventive concept. Referring to FIGS. 1 to 5, the mobile device 210 may operate as follows.

The mobile device 210 may perform first communication with a host device 100 via a main channel (S131). Here, the first communication may operate as a default. The mobile device 210 may determine a possibility of disconnection of the first communication (S132). For example, the possibility may be based on stored data relating to such a communication, such as the type of mobile device 210, a power being used for the connection, etc. When the first communication has a high possibility of disconnection, the mobile device 220 may perform second communication with the host device 100 using a sub channel via another mobile device (S133). Conversely, when the first communication does not have a high possibility of disconnection, operation S131 may be entered.

A mobile device according to an example embodiment of the present inventive concept may be implemented to set a communication mode as a default operation, and to change the communication mode based on a particular setting.

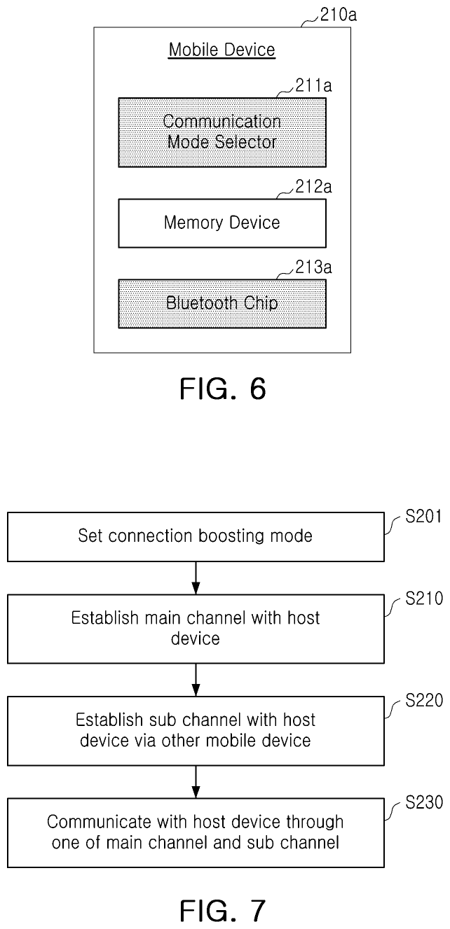

FIG. 6 is a diagram illustrating a mobile device 210a according to another example embodiment of the present inventive concept. Referring to FIG. 6, the mobile device 210a may include a communication mode selector 211a, a memory device 212a, and a communication chip 213a.

The communication mode selector 211a may be implemented to select a connection boosting mode according to selection of a user, an internal policy, or an external request. Here, the connection boosting mode may refer to a communication mode using an interconnection between Bluetooth™ devices. The communication mode selector 211a may be implemented using, for example, computer program code that accepts various input values and controls whether to use the interconnection communication mode based on the input values.

FIG. 7 is a flowchart illustrating a method of operating a mobile device according to an example embodiment of the present inventive concept. Referring to FIGS. 6 and 7, a communication operation of the mobile device 210a may be performed as follows.

The mobile device 210a (e.g., a first mobile device) may set a connection boosting mode (S201). In the connection boosting mode, the mobile device 210a may establish a main channel with a host device 100 (S210). At the same time, in the connection boosting mode, the mobile device 210a may establish a sub channel via the host device 100 and another mobile device (e.g., a second mobile device). In this case, a data synchronization operation may be performed between the mobile device 210a and the other mobile device (S220). Thereafter, the mobile device 210a may communicate with the host device 100 via one of the main channel and the sub channel (S230). Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be described elsewhere with a different ordinal number (e.g., “second” in the specification or another claim).

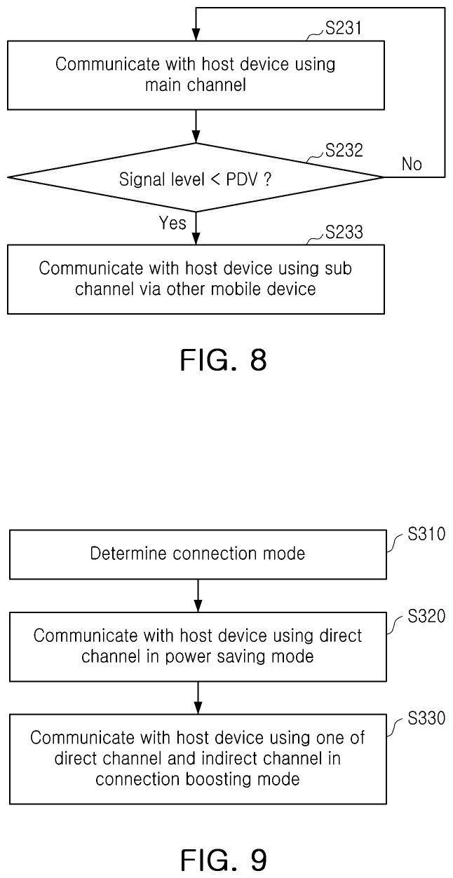

FIG. 8 is a flowchart illustrating a method of operating a mobile device according to an example embodiment of the present inventive concept. FIG. 8 is a diagram illustrating a method of operating the mobile device 210a.

The mobile device 210a may communicate with the host device 100 using the main channel (231). The mobile device 210a may monitor a level of a communication signal and determine whether the monitored level of the signal (e.g., signal strength) has a value less than a reference value PDV (S232). When the signal level has a value less than the reference value PDV, the mobile device 210b may perform communication with the host device 100 using a sub channel via another mobile device (S233). Conversely, when the value of the level of the signal is not less than the reference value PDV, operation S231 may be entered. For example, in some embodiments, the reference value PDV may be a value a particular amount greater than a signal strength that would typically result in a lost or interrupted communication. This way, the sub channel communication can begin prior to any signal disruption so that communication remains uninterrupted.

A mobile device according to an example embodiment of the present inventive concept may be implemented to determine a connection mode and to vary a communication channel according to the determined connection mode.

FIG. 9 is a flowchart illustrating a method of operating a mobile device according to another example embodiment of the present inventive concept. Referring to FIG. 9, an operation of the mobile device 210a may be performed as follows.

The mobile device 210a may determine a connection mode with a host device 100 (S310). When the connection mode is a power reduction mode, the mobile device 210a may communicate with the host device 100 using a direct channel. Here, the direct channel may refer to a channel performing inter-layer communication between a host device and a slave device. In order to save power, in some embodiments, an intermediate mobile device is not used for any communication between the mobile device 210a and the host device 100.

Conversely, when the connection mode is a connection boosting mode, the mobile device 210a may communicate with the host device using one of the direct channel or an indirect channel (S330). Here, the indirect channel may refer to a communication channel via an interconnection between Bluetooth™ devices, as described with reference to FIGS. 1 to 8.

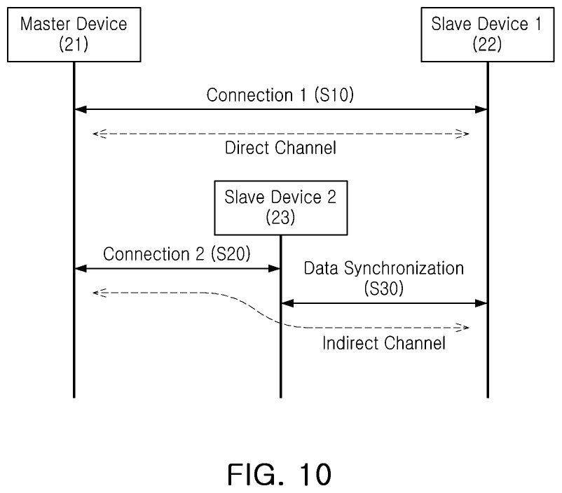

FIG. 10 is a ladder diagram illustrating a communication connection of a wireless communication system according to an example embodiment of the present inventive concept. Referring to FIG. 10, the wireless communication system may include a master device 21 and slave devices 22 and 23.

The master device 21 may establish a first connection with the first slave device 22 via a first pairing operation (S10). Here, the first connection may be used as a direct channel (or main channel) between the master device 21 and a first slave device 22.

In addition, the master device 21 may establish a second connection with the second slave device 23 via a second pairing operation (S20). The first slave device 22 and the second slave device 23 may perform a data synchronization operation with each other in a connection boosting mode (S30). Here, the second connection may be used as an indirect channel (or sub-channel) between the master device 21 and the first slave device 22. The data synchronization may refer to data sharing and timing synchronization between the first slave device 22 and the second slave device 23 in order to allow one of the first slave device 22 and the second slave device 23 to serve as an intermediary/router for the other of the first slave device 22 and the second slave device 23.

In an example embodiment, the second slave device 23 may perform a hub function using a second layer connection and interconnection. In an example embodiment, the first slave device 22 may communicate with the master device 21 using a direct channel according to a first layer connection. In an example embodiment, the first slave device 22 may communicate with the master device 21 using an indirect channel according to the second layer connection and interconnection (e.g., a second layer connection between the first slave device 22 and second slave device 23, and an interconnection between the second slave device 23 and the master device 21). In an example embodiment, the first slave device 23 may simultaneously communicate with the master device 21 using the direct channel according to the first layer connection and the indirect channel according to the second layer connection and interconnection. In some embodiments, in a first mode, both the first slave device 1 and the second slave device 2 may communicate directly with the master device 21 for independent control of the first slave device 1 and the second slave device 2 by the master device 21. In a different mode, the slave device 2 may be used as an interconnection device, as described above. In some embodiments, the second slave device 2 in this situation can still perform its roles as a slave device under control of the master device 21, in addition to serving as an interconnection device, while in other embodiments, in this different mode, the second slave device 2 can switch to performing interconnection communications without performing its operation as a slave device to the master device 21. Computer program code stored in the master device 21 and/or the slave device 1 and slave device 2 could be configured to cause these different operations, for example, based on an automatic control program or based on the control of a user.

The inventive concept of the various embodiments may be applicable to an electronic device.

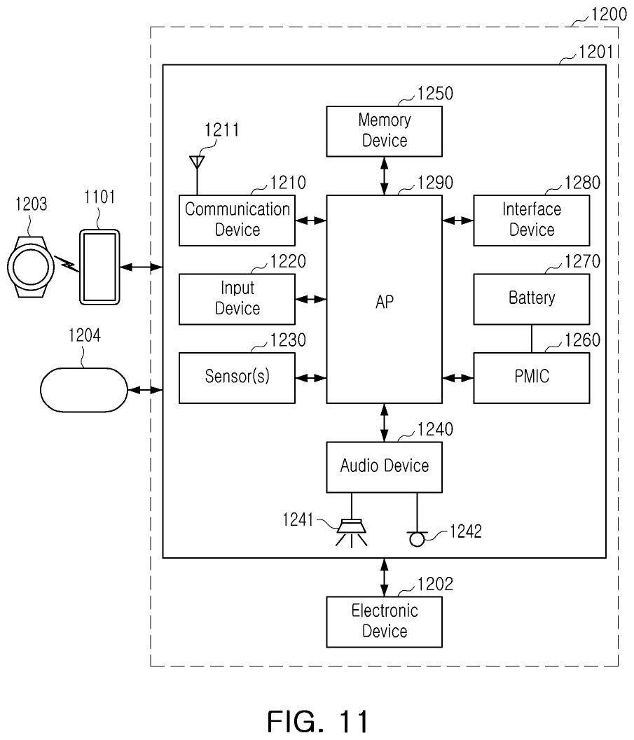

FIG. 11 is a diagram illustrating an electronic device 1200 according to an example embodiment of the present inventive concept. Referring to FIG. 11, the electronic device 1200 may include a master device 1201 and a slave device 1202. As described with reference to FIGS. 1 to 10, the electronic device 1200 may be implemented to perform wireless communication using a layer connection/interconnection between a master device and a slave device.

The master device 1201 may include a communication device 1210, an input device 1220, a sensor 1230, an audio device 1240, a memory device 1250, a power management chip 1260, a battery 1270, an interface device 1280, and a processor 1290 (AP).

The processor 1290 may be implemented to execute software to control at least one other component (for example, hardware or software component) of the master device 1201 connected to the processor 1290, or to perform various data processing or computation. In an example embodiment, as at least part of data processing or calculation, the processor 1290 may load a command or data received from another component (for example, the sensor device 1230 or the communication device 1210) into a volatile memory device 1250, process the command or data stored in the volatile memory, and store resulting data in a nonvolatile memory.

In an example embodiment, the processor 1290 may verify whether an electrical connection is formed between the master device 1201 and a charging device 1204 via the sensor device 1230 or an interface 1280. In an example embodiment, the processor 1290 may recognize a magnet installed in the charging device 1204 via a magnetic sensor (for example, a hall sensor) included in the sensor device 1230, thereby verifying that the magnet is disposed in the master device 1201 or the charging device 1204 or in the vicinity of the charging device 1204. In an example embodiment, the processor 1290 may recognize that a connection terminal included in the interface 1280 is in contact with a connection terminal installed in a mounting portion of the charging device 1204, thereby verifying whether an electrical connection is established between the master device 1201 and the charging device 1204. In an example embodiment, the processor 1290 may verify, via the sensor device 1230, whether the master device 1201 is worn on a user's ears.

In an example embodiment, when the master device 1201 communicates with the slave device 1202, the master device 1201 may be a master device controlling communication of the slave device 1202, and the slave device 1202 may be a slave device. In an example embodiment, the master device 1201 may establish a communication connection with the electronic device 1101 and receive data (for example, audio data) from the electronic device 1101 via the established communication connection. The master device 1201 may transmit voice data (for example, information on a voice signal) to the electronic device 1101 via the established communication connection.

In an example embodiment, the slave device 1202 may obtain data (for example, audio data) transmitted by the electronic device 1101 without establishing a direct communication connection with the electronic device 1101. For example, the slave device 1202 may receive, from the master device 1201, data (for example, an audio signal) received by the master device 1201 from the electronic device 1101, or detect a communication connection established between the master device 1201 and the electronic device 1101 using communication parameters for the communication connection established between the master device 1201 and the electronic device 1101, and obtain (that is, sniff) data (for example, audio data) transmitted by the electronic device 1101 via a communication connection. In an example embodiment, the slave device 1202 may establish a communication connection with the electronic device 1101 and may receive data (for example, audio data) from the electronic device 1101 via the established communication connection. In an example embodiment, after master device 1201 is communication-connected to the slave device 1202, the master device 1201 may be converted into a slave device, and the slave device 1202 may be converted into a master device.

In an example embodiment, the master device 1201 may further include various devices according to a provision form thereof. All types of components cannot be listed because a variation on the components greatly varies according to the convergence trend of digital devices, but the master device 1201 according to an example embodiment may further include a component on a level equal to that of the above-described components. In addition, in the master device 1201 according to an example embodiment, particular components may be excluded from the above-described components or replaced with other components according to the provision form thereof. Such a configuration could be easily understood by those skilled in the art.

In an example embodiment, the slave device 1202 paired with the master device 1201 may include components included in the master device 1201 in the same manner or a similar manner.

In an example embodiment, the electronic device 1101 may include a wireless communication device 1192 and at least one processor functionally connected to the wireless communication device. The at least one processor may be implemented to transmit audio data to the master device 1201 connected to the electronic device via the wireless communication device, detect audio disconnection occurring in at least one of the master device and a slave device 1202, control at least one of the slave device and an external electronic device 1203 such that the slave device is connected to the external device 1203 when audio disconnection is detected, transmit first audio data for the master device to the slave device via the wireless communication device, and control the external electronic device via the wireless communication device such that the external electronic device transmits second audio data for the slave device to the slave device.

In an example embodiment, the at least one processor may be configured to transmit, to the slave device, synchronization information for synchronizing playback of the first audio data in the master device and playback of the second audio data in the slave device, via the external electronic device. In an example embodiment, the synchronization information may include time information for determining a playback point of time of the second audio data in the slave device. In an example embodiment, the at least one processor may be configured to transmit, to the master device, the synchronization information for synchronizing playback of the first audio data in the master device and playback of the second audio data in the slave device. In an example embodiment, the synchronization information may include a delay value representing a delay between the master device and the slave device. In an example embodiment, the at least one processor may control the master device such that the master device plays the first audio data with a delay by a delay value.

In an example embodiment, when a signal, representing that an amount of buffer stored in a reception buffer of the master device exceeds a specified threshold value, is received from the master device, the at least one processor may determine that audio disconnection occurs.

In an example embodiment, the at least one processor may receive, from the master device, information on at least one of a transmission rate or a received signal strength related to audio data received by the master device from the electronic device, and may determine, based on the received information, whether audio disconnection occurs. In an example embodiment, the at least one processor may receive, from the master device, a change request signal representing that audio disconnection has occurred. The change request signal may include a Bluetooth™ device address of the slave device. The at least one processor may transmit, to the external electronic device, a connection request signal including the Bluetooth™ device address of the slave device. In an example embodiment, when audio disconnection is detected, the at least one processor may determine whether the external electronic device is worn on a user's body. When the external electronic device is worn on the user's body, a connection request, including the Bluetooth™ device address of the slave device, may be transmitted to the external electronic device.

The devices described above may be implemented as a hardware component, a software component, and/or a combination of the hardware component and the software component. For example, a device and a component according to example embodiments may be implemented using one or more general purpose or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. A processing device may include an operating system (OS) and one or more software applications executed on the operating system. In addition, the processing device may also access, store, manipulate, process, and generate data in response to execution of software. For ease of understanding, in some case, it is described that the processing device is used a single processing element, but those skilled in the art will recognize that the processing device may include a plurality of processing elements or multiple types of processing elements. For example, the processing device may include a plurality of processors, or one processor and one controller. In addition, other processing configurations are also possible, such as parallel processors.

The software may include a computer program, a code, an instruction, or one or more combinations thereof, and may configure the processing device to operate as desired, or may independently or collectively instruct the processing device. The software and/or data may be embodied in any type of machine, component, physical device, virtual equipment, computer storage medium, or device so as to be interpreted by the processing device, or to provide instructions or data to the processing device. The software may also be distributed on a computer system via a network, and may be stored or executed in a distributed manner. The software and data may be stored on one or more computer-readable recording media.

Generally, Bluetooth connections are primarily based on the vertical connections between the host and slave layers of a single device. As a result, signal loss or delay can occur when interference or signal shadow areas arise. To address this issue, aspects of the present invention may establish multiple connections to the target mobile device by adding interconnections within the same layer, in addition to the hierarchical connection structure between the host and slave. The present invention relates to a technology that changes the conventional 1:1 host-slave connection to an N:N host-connection, performing connection boosting. Specifically, the invention introduces a technology that uses another slave device, which is configured to be connected but not used directly, as a hub for connection boosting.

Beyond the conventional hierarchical connection structure, aspects of the present invention may prevent disconnections due to coverage degradation by enabling interconnections within the same layer, and it can continue data transmission using a detour path when connection instability occurs, monitoring the signal strength between the host and slave, hence preventing signal interruptions. Aspects of the present invention may consider using another connected slave device, which is not normally used directly, as a hub for connection boosting. For instance, the present invention may use a wireless earphone charging case as a connection hub to aid the connection between wireless earphones (slave) and a mobile phone (host).

Aspects of the present invention may also enable the release of accessories dedicated to connection hubs. It may allow for long-term use by embedding a Bluetooth connection hub feature in small devices in the form of necklaces or keychains, or in portable charging batteries. The present invention may be applied to wireless audio devices like microphones/headphones (earphones) where maintaining a constant connection for uninterrupted data streaming is more important than exclusive speed. The mobile device and the operation method according to the embodiments of the present invention may transmit the host's data through interconnections between slave devices in the wireless connection hierarchy.

In a mobile device, the wireless communication system for the mobile device, and the method of operating the mobile device according to an example embodiment of the present inventive concept, a Bluetooth™ connection may be boosted via an interconnection among Bluetooth™ devices, thereby preventing crosstalk or signal blockage.

While example embodiments have been illustrated and described above, it will be apparent to those skilled in the art that modifications and variations could be made without departing from the scope of the present invention as defined by the appended claims.

1. A method of operating a mobile device, the method comprising:
establishing a main channel between a first mobile device and a host device;
establishing a sub channel between the first mobile device and the host device via a second mobile device; and
communicating between the first mobile device and the host device using one of the main channel and the sub channel.

2. The method of claim 1, wherein the main channel and the sub channel are established according to a short-range wireless communication protocol.

3. The method of claim 1, wherein the communicating includes:
communicating between the first mobile device and the host device using the main channel;
determining a likelihood of disconnection to the main channel; and
communicating with the host device using the sub channel, when the likelihood of disconnection has a value greater than or equal to a reference value.

4. The method of claim 1, further comprising:
setting a connection boosting mode supporting the sub channel.

5. The method of claim 4, wherein the establishing the sub channel includes establishing the sub channel when an operation mode is the connection boosting mode.

6. The method of claim 5, further comprising:
determining whether a signal strength level of a signal transmitted from the main channel has a value less than a reference value.

7. The method of claim 6, wherein the communicating includes communicating with the host device using the sub channel, when the signal strength level of the signal has the value less than the reference value.

8. The method of claim 1, further comprising:
determining a connection mode of wireless communication.

9. The method of claim 8, wherein direct communication is performed using the main channel directly connected to the host device without establishing the sub channel, when the connection mode is a power reduction mode.

10. The method of claim 8, wherein communication is performed using one of the main channel and the sub channel, when the connection mode is a connection boosting mode.

11. A mobile device comprising:
a memory device configured to store transmission data or reception data; and
a communication chip configured to transmit the transmission data to an external host device via wireless communication or receive the reception data from the host device via the wireless communication,
wherein the communication chip establishes a main channel with the host device via a layer connection with the host device or establishes a sub channel with the host device via an interconnection with another mobile device, and communicates with the host device using one of the main channel and the sub channel.

12. The mobile device of claim 11, wherein:
the wireless communication is short-range wireless communication, and
the other mobile device is connected to the host device to perform a hub function.

13. The mobile device of claim 11, further comprising:
a communication mode selector configured to set a connection mode of the wireless communication.

14. The mobile device of claim 13, wherein:
the connection mode includes a power reduction mode and a connection boosting mode,
only the main channel is established in the power reduction mode, and
both the main channel and the sub channel are established in the connection boosting mode.

15. The mobile device of claim 11, wherein the communication chip performs communication using the sub channel, when a possibility of disconnection of communication using the main channel has a value greater than or equal to a reference value.

16. A wireless communication system comprising:
a first mobile device configured to communicate with a host device; and
a second mobile device configured to communicate with the host device,
wherein the first mobile device is configured to establish a main channel between the first mobile device and the host device according to a direct connection, and to establish a sub channel between the first mobile device and the host device according to an interconnection through the second mobile device.

17. The wireless communication system of claim 16, wherein
the host device is a smartphone,
each of the first mobile device and the second mobile device is one of an earphone, a headset, a speaker, a charger, an external battery, and a smartwatch.

18. The wireless communication system of claim 16, wherein the host dev (ice and the first mobile device are configured to establish the main channel and the sub channel via a short-range wireless communication pairing process.

19. The wireless communication system of claim 16, wherein the first mobile device establishes only the main channel without establishing the sub channel, when a connection mode is a power reduction mode.

20. The wireless communication system of claim 16, wherein the first mobile device simultaneously establishes the main channel and the sub channel, and communicates with the host device using one of the main channel and the sub channel, when a connection mode is a connection boosting mode.

21-24. (canceled)
